(19) United States
(12) Patent Application Publication
(10) Pub. No.: US 2015/0034499 A1
(43) Pub. Date: Feb. 5, 2015

(54) DETERMINATION METHODS

(71) Applicant: DELBio, Inc., Taoyuan County (TW)

(72) Inventors: Miao-Ju YEN, Taoyuan County (TW); Po-Chin NIEN, Taoyuan County (TW); Chi-Yan CHEN, Taoyuan County (TW); Bo-Jiun SHEN, Taoyuan County (TW)

(21) Appl. No.: 14/448,192

(22) Filed: Jul. 31, 2014

Related U.S. Application Data
(60) Provisional application No. 61/861,792, filed on Aug. 2, 2013.

(51) Int. Cl. G01N 27/327

(52) U.S. Cl. CPC G01N 27/327
USPC 205/792

(57) ABSTRACT

A determination method is provided. The determination method is performed for a biochemistry detection strip which includes first and second electrodes and a reaction area coupled to the first and second electrodes. The determination method includes steps of: disposing a to-be-detected object in the reaction area; applying a first voltage to the reaction area through the first and second electrodes to obtain a first value; stopping applying the first voltage to the reaction area for a first period; applying a second voltage to the reaction area through the first and second electrodes to obtain a second value; stopping applying the second voltage to the reaction area for a second period; and obtaining a determination index, which represents a filling situation of the to-be-detected object in the reaction area, according to the first and second values. Polarities of the first and second voltages are inverse to each other.

### CROSS REFERENCE TO RELATED APPLICATIONS

This application claims the benefit of U.S. Provisional Application No. 61/861,792, filed on Aug. 2, 2013, the contents of which are incorporated herein by reference.

### BACKGROUND OF THE INVENTION

1. Field of the Invention

The invention relates to a determination method, and more particularly to a determination method for determining a filling situation of a to-be-detected object in a reaction area of a biochemistry detection strip.

2. Description of the Related Art

In current bio-sensing techniques, a corresponding signal is generated through chemical reaction between a reaction reagent on a biochemistry detection strip and a biomolecular object, and then the corresponding signal is analyzed to determine features of the biomolecular object, including its concentration, volume, weight, and component proportions. During the sensing operation, whether there is sufficient quantity of the biomolecular object in the reaction area of the biochemistry detection strip will influence the measurement of the features of the biomolecular object. For example, a blood glucose meter provides a blood glucose measurement by performing a chemical reaction with an enzyme and blood from a body part, such as a fingertip of a user, on a biochemistry detection strip. When the to-be-detected blood does not fill the reaction area, the blood glucose value obtained by the blood glucose measurement is lower than the actual blood glucose, which causes misjudgment of the blood glucose value. Accordingly, treatment opportunities for the user may be missed, or the user may take an inappropriate amount of modification, or a user's life may be threatened.

### BRIEF SUMMARY OF THE INVENTION

Thus, it is desirable to provide a determination to determine for a filling situation of a to-be-detected object in a reaction area of a biochemistry detection strip.

An exemplary embodiment of a determination method is provided. The determination method is performed for a biochemistry detection strip which comprises a first electrode, a second electrode, and a reaction area coupled to the first electrode and the second electrode. The determination method comprises steps of: disposing a to-be-detected object in the reaction area; applying a first voltage to the reaction area through the first electrode and the second electrode to obtain a first value; stopping applying the first voltage to the reaction area for a first period; applying a second voltage to the reaction area through the first electrode and the second electrode to obtain a second value; stopping applying the second voltage to the reaction area for a second period; and obtaining a determination index, which represents a filling situation of the to-be-detected object in the reaction area, according to the first value and the second value. A polarity of the first voltage and a polarity of the second voltage are inverse to each other.

Another exemplary embodiment of a determination method is provided. The determination method is performed for a biochemistry detection strip which comprises a first electrode, a second electrode, and a reaction area coupled to the first electrode and the second electrode. The determination method comprises steps of (A) disposing a to-be-detected object in the reaction area; (B) applying a first voltage to the reaction area through the first electrode and the second electrode to obtain a first value; (C) stopping applying the first voltage to the reaction area for a first period; (D) applying a second voltage to the reaction area through the first electrode and the second electrode to obtain a second value; (E) stopping applying the second voltage to the reaction area for a second period; and (F) repeatedly performing the steps (B)˜(E) at least once and obtaining a determination index, which represents a filling situation of the to-be-detected object in the reaction area, according to the obtained first values and the obtained second values.

In one embodiment, a polarity of the first voltage and a polarity of the second voltage are inverse to each other.

Another exemplary embodiment of a determination method is provided. The determination method is performed for a biochemistry detection strip which comprises a first electrode, a second electrode, and a reaction area coupled to the first electrode and the second electrode. The determination method comprises steps of disposing a to-be-detected object in the reaction area; applying a first voltage and a second voltage, which increase or decrease gradually, to the reaction area through the first electrode and the second electrode to respectively obtain a first value and a second value; stopping applying the first voltage and the second voltage to the reaction area for a first period; applying a third voltage and a fourth voltage, which increase or decrease gradually, to the reaction area through the first electrode and the second electrode to respectively obtain a third value and fourth value; and obtaining a determination index, which represent a filling situation of the to-be-detected object in the reaction area, according to the first value, the second value, the third value, and the fourth value.

In one embodiment, a polarity of the first voltage and a polarity of the fourth voltage are inverse to each other, and a polarity of the second voltage and a polarity of the third voltage are inverse to each other. In another embodiment, a polarity of the first voltage and a polarity of the second voltage are the same, and a polarity of the third voltage and a polarity of the fourth voltage are the same.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a biochemistry detection system;

FIG. 2 is a schematic view showing variation of a voltage applied to a reaction area 130 according to one exemplary embodiment;

FIG. 3 is a flow chart of one exemplary embodiment of a determination method;

FIG. 4 is a schematic view showing variation of a voltage applied to a reaction area 130 according to another exemplary embodiment;

FIG. 5 is a flow chart of another exemplary embodiment of a determination method;

FIG. 6 is a schematic view showing variation of a voltage applied to a reaction area 130 according to further another exemplary embodiment;

FIG. 7 is a schematic view showing variation of a voltage applied to a reaction area 130 according to one exemplary embodiment; and

FIG. 8 is a schematic view showing variation of a voltage applied to a reaction area 130 according to another exemplary embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

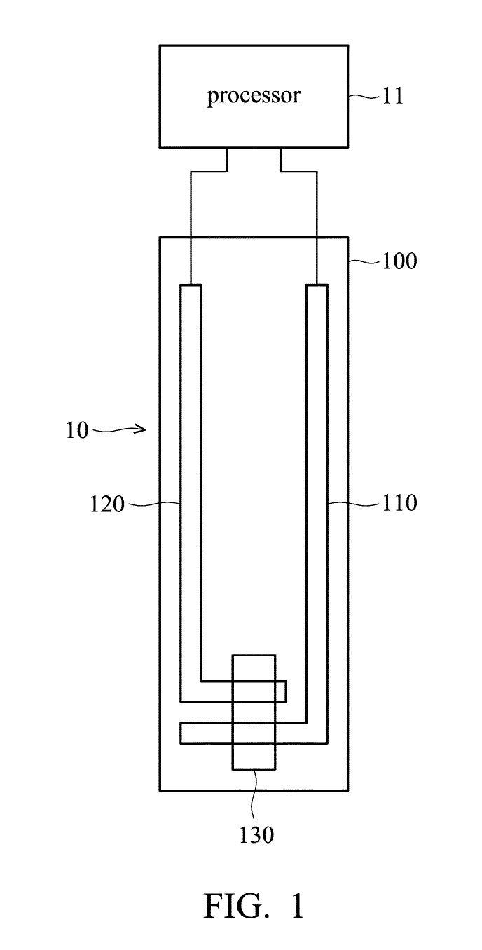

FIG. 1 shows an exemplary embodiment of a biochemistry detection system. A biochemistry detection system 1 of the embodiment is used to detect features of a biomolecular object, such as concentration, volume, weight, and component proportions. Referring to FIG. 1, the biochemistry detection system 1 comprises a biochemistry detection strip 10 and a processor 11. The biochemistry detection strip 10 comprises a substrate 100 and electrodes 110 and 120. Moreover, there is an insulating layer on the front terminal of the biochemistry detection strip 10. The insulating layer is used to define a reaction area 130. When a to-be-detected object collected from a user (such as blood, which is a biomolecular object) is dropped, absorbed, or disposed in the reaction area 130, a chemical action is performed with at least one analyte of the to-be-detection object and reaction reagent in the reaction area 130. The electrodes 110 and 120 are formed on the substrate 100 and coupled to the processor 11 and the reaction area 130. In the embodiment, both of the electrodes 110 and 120 cross the reaction area 130, as shown in FIG. 1. Moreover, in the embodiment, the material of the substrate 100 can be polyvinyl chloride, polystyrene, polyester, polycarbonate, polyether, polyethylene, polypropylene, polyethylene terephthalate, polyethylene terephthalate, silicon dioxide, or aluminium oxide. The material of the electrodes 110 and 120 can be carbon, metal, alloy, or an other conductive material. The reaction reagent in the reaction area 130 at least includes electron transfer substances and other substances, such as enzyme, macromolecules, stabilizer, and so on.

When it is desirable to detect a certain feature (such as blood glucose) of a biomolecular object, the biomolecular object is disposed in the reaction area 130. After the biomolecular object is disposed in the reaction area 130, the processor 11 applies a plurality of direct current (DC) voltages to the reaction area 130 intermittently, thereby obtaining a determination index which represents a filling situation of the biomolecular object in the reaction area 130. The filling situation of the biomolecular object in the reaction area 130 may influence the detection accuracy of the biochemistry detection system 1. Thus, the biochemistry detection system 1 can correct the detection values of the features of the biomolecular object by the obtained determination index, thereby enhancing the detection accuracy. In the following, the obtaining of the determination index will be described.

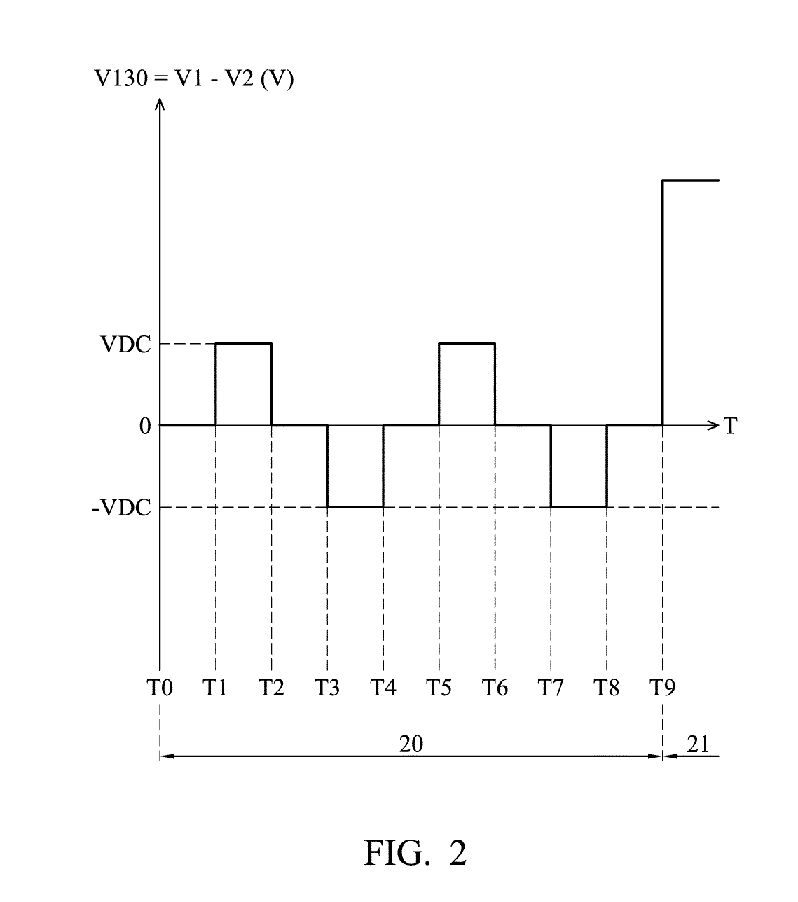

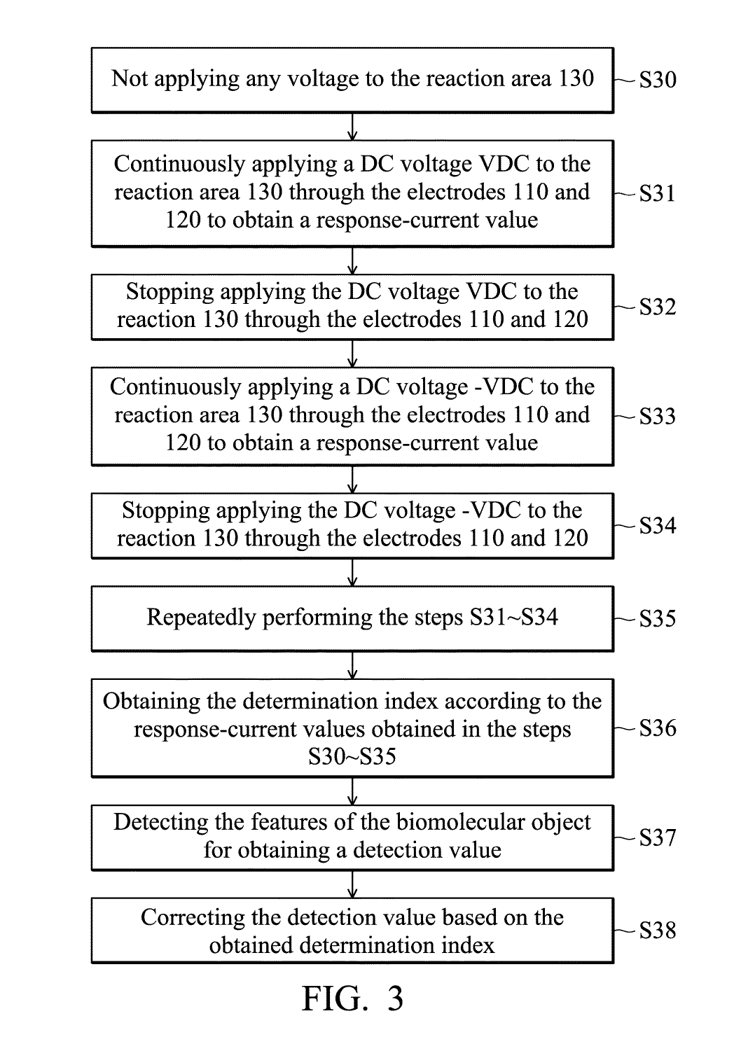

FIG. 2 is a schematic view showing variation of a voltage applied to the reaction area 130 according to one exemplary embodiment. FIG. 3 is a flow chart of one exemplary embodiment of a determination method. A voltage V130 shown in FIG. 2 is defined by the difference between the voltages on the electrodes 110 and 120. In detailed, the voltage V130 is obtained by subtracting the voltage V2 on the electrode 120 from the voltage V1 on the electrode 110 (V1−V2). The biochemistry detection system 1 can operate in a filling determination mode 20 and a detection mode 21. In the following, the embodiment will be described by referring to FIGS. 2 and 3. In the embodiment of FIG. 2, before the biochemistry detection system 1 enters the detection mode 21, which occurs after the time point T9, the biochemistry detection system 1 operates in the filling determination mode 20 which occurs from the time point T0 to the time point T9. In the filling determination mode 20, in the period from the time point T0 to the time point T1, the processor 11 does not provide any voltage to the electrodes 110 and 120. That is the processor 11 does not apply any voltage to the reaction area 130 through the electrodes 110 and 120 (V130=V1−V2=0 volt (V)) (step S30). In the period form the time point T1 to a time point T2, the processor 11 provides a DC voltage VDC to the electrode 110 and further provides no voltage to the electrode 120. That is, in the period from the time point T1 to the time point T2, the processor 11 continuously applies the DC voltage VDC (V130=V1−V2=VDC) to the reaction area 130 through the electrodes 110 and 120 (step S31). At this time, the processor 11 obtains a response-current value in response to the DC voltage VDC through the electrodes 110 and 120.

Then, in the period from the time point T2 to the time point T3, the processor 11 stops providing the DC current VDC to the electrode 110 and still provides no voltage to the electrode 120, that is, the processor 11 stops applying the DC voltage VDC to the reaction 130 through the electrodes 110 and 120 (V130=V1−V2=0V) (step S32). From the time point T3 to a time point T4, the processor 11 switches to provide the DC voltage VDC to the electrode 120 and further provides no voltage to the electrode 110. That is, in the period from the time point T3 to the time point T4, the processor 11 continuously applies a DC voltage −VDC (V130=V1−V2=−VDC) to the reaction area 130 through the electrodes 110 and 120 (step S33). At this time, the processor 11 obtains a response-current value in response to the DC voltage −VDC through the electrodes 110 and 120. After that, in the period from the time point T4 to the time point T5, the processor 11 stops providing the DC current to the electrode 120 and still provides no voltage to the electrode 110, that is, the processor 11 stops applying the DC voltage −VDC to the reaction 130 through the electrodes 110 and 120 (V130=V1−V2=0V) (step S34). In the following, the voltage-applying operation performed by the processor 11 in the period from the time point T5 to the time point T9 is the same as the voltage-applying operation performed by the processor 11 in the period from the time point T1 to the time point T5 (that is the voltage-applying operation in the step S31˜S34 is repeated) (step S35). Thus, the related description is omitted here. Afterwards, the processor 11 obtains the determination index according to the response-current values obtained in the steps S30˜S35 (step S36).

According to FIG. 2, the processor 11 intermittently applies the voltage V130 to the reaction area 130 through the electrodes 110 and 120. Moreover, since the DC voltage VDC is provided alternately to the electrodes 110 and 120, the polarity of the applied voltage is switched for the electrodes, and the induced response-current is switched between two directions. The several response-current values, which are obtained by intermittently applying the voltage V130 to the reaction area 130, are processed by a specific operation of the processor 11 to obtain the determination index representing the filling situation of the biomolecular object in the reaction area 130. In the embodiment, the specific operation can be multiplication, division, ratio power functions, or logarithm.

After the time point T9, the biochemistry detection system 1 enters the detection mode 21 and then performs a specific detection operation (such as a blood glucose detection operation) to the biomolecular object to detect the features of the biomolecular object for obtaining a detection value (step S37). In the detection mode 21, the detection value is corrected based on the obtained determination index (step S38), thereby enhancing the detection accuracy. In the embodiment, when the biochemistry detection system 1 enters the detection mode 21, the voltage which is provided to the reaction area 130 through the electrodes 110 and 120 is higher than the DC voltage VDC.

In the embodiment of FIG. 2, the DC voltage CDV which is provided to the electrodes 110 and 120 by the processor 11 is in the range of 0.001˜0.1V. In an embodiment, the DC voltage VDC which is provided to the electrodes 110 and 120 is 0.02V. In other words, in the period from the time point T1 to the time point T2 and the period from the time point T5 to the time point T6, the processor 11 applies the voltage V130 of 0.001˜0.1V to the reaction area 130 through the electrodes 110 and 120; and in the period from the time point T3 to the time point T4 and the period from the time point T7 to the time point T8, the processor 11 applies the voltage V130 of −0.001˜−0.1V to the reaction area 130 through the electrodes 110 and 120. In an embodiment, in the period from the time point T1 to the time point T2 and the period from the time point T5 to the time point T6, the processor 11 applies the voltage V130 of 0.02V to the reaction area 130 through the electrodes 110 and 120; and in the period from the time point T3 to the time point T4 and the period from the time point T7 to the time point T8, the processor 11 applies the voltage V130 of −0.02V to the reaction area 130 through the electrodes 110 and 120.

In the embodiment, the length of each of the periods from the time point T0 to the time point T1, from the time point T1 to the time point T2, from the time point T2 to the time point T3, from the time point T3 to the time point T4, from the time point T4 to the time point T5, from the time point T5 to the time point T6, from the time point T6 to the time point T7, and from the time point T7 to the time point T8 is in a range of 0.01˜1 second (s). In an embodiment, the length of each period between the every two continuous time points listed above is 0.2 S. In another embodiment, the lengths of the periods each between the every two continuous time points listed above are different. For example, the length of each of the periods from the time point T1 to the time point T2, from the time point T3 to the time point T4, the time point T5 to the time point T6, and the time point T7 to the time point T8 is longer than the length of each of the periods from the time point T0 to the time point T1, from the time point T2 to the time point T3, from the time point T4 to the time point T5, and from the time point T6 to the time point T7.

In the embodiment of FIG. 2, the filling determination mode 20 occurs before the biochemistry detection system 1 enters the detection mode 21. In other embodiments, the biochemistry detection system 1 operates in the detection mode 21 to obtain the detection value and then enters the filling determination mode 20 to obtain the determination index. After the determination index is obtained, the detection value is processed according to the determination index, such as, for warning users, abnormally terminating the detection procedure, or correcting the detection value.

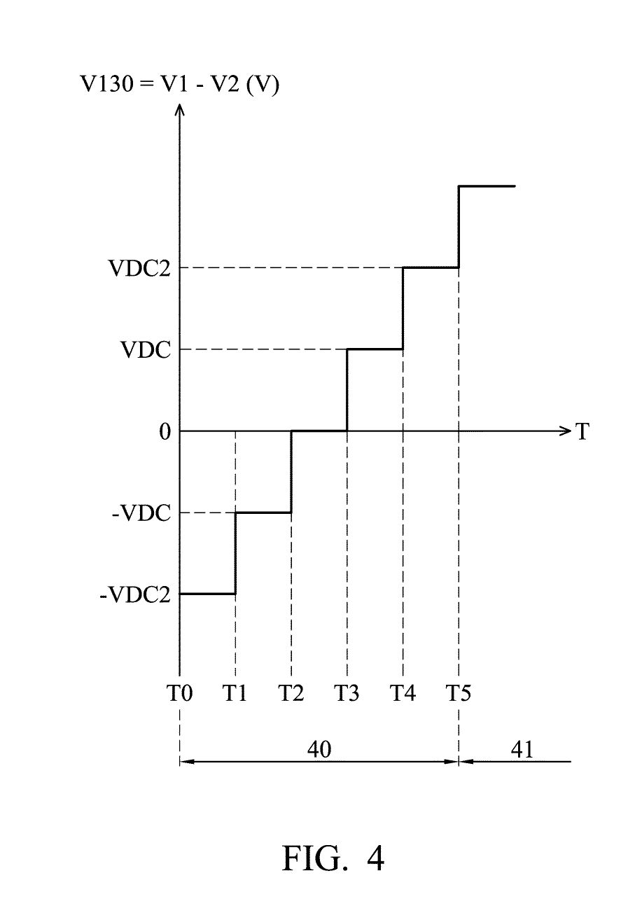

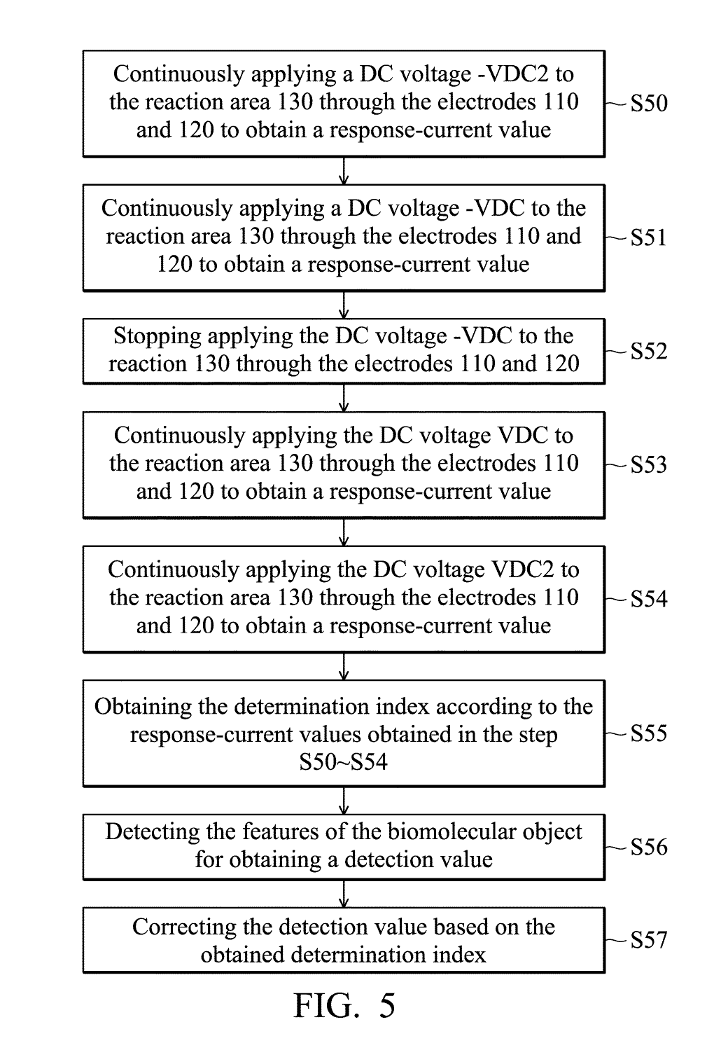

FIG. 4 is a schematic view showing variation of a voltage applied to the reaction area 130 according to another exemplary embodiment. FIG. 5 is a flow chart of another exemplary embodiment of a determination method.

A voltage V130 shown in FIG. 4 is defined by the difference between the voltages on the electrodes 110 and 120. In detailed, the voltage V130 is obtained by subtracting the voltage V2 on the electrode 120 from the voltage V1 on the electrode 110 (V1−V2). The biochemistry detection system 1 can operate in a filling determination mode 40 and a detection mode 41. In the following, the embodiment will be described by referring to FIGS. 4 and 5. In the embodiment of FIG. 4, before the biochemistry detection system 1 enters the detection mode 41 which occurs after the time point T5, the biochemistry detection system 1 operates in the filling determination mode 40 which occurs from the time point T0 to the time point T5 first. In the filling determination mode 40, in the period from the time point T0 to the time point T1, the processor 11 provides a DC voltage VDC2 to the electrode 120 and further provides no voltage to the electrode 110. That is, in the period from the time point T0 to the time point T1, the processor 11 continuously applies a DC voltage −VDC2 (V130=V1−V2=−VDC2) to the reaction area 130 through the electrodes 110 and 120 (step S50). At this time, the processor 11 obtains a response-current value in response to the DC voltage −VDC2 through the electrodes 110 and 120. In the period from the time point T1 to the time point T2, the processor 11 provides a DC voltage VDC to the electrode 120 and continuously provides no voltage to the electrode 110. That is, in the period from the time point T1 to the time point T2, the processor 11 continuously applies a DC voltage −VDC (V130=V1−V2=−VDC) to the reaction area 130 through the electrodes 110 and 120 (step S51). At this time, the processor 11 obtains a response-current value in response to the DC voltage −VDC through the electrodes 110 and 120. In the embodiment, the level of the DC voltage VDC2 is higher than the level of the DC voltage VDC.

Then, in the period from the time point T2 to the time point T3, the processor 11 stops providing the DC current VDC to the electrode 120 and still provides no voltage to the electrode 110, that is, the processor 11 stops applying the DC voltage −VDC to the reaction 130 through the electrodes 110 and 120 (V130=V1−V2=0V) (step S52). In the period from the time point T3 to the time point T4, the processor 11 provides the DC voltage VDC to the electrode 110 and continuously provides no voltage to the electrode 120. That is, in the period from the time point T3 to the time point T4, the processor 11 continuously applies the DC voltage VDC (V130=V1−V2=VDC) to the reaction area 130 through the electrodes 110 and 120 (step S53). At this time, the processor 11 obtains a response-current value in response to the DC voltage VDC through the electrodes 110 and 120. Then, in the period from the time point T4 to the time point T5, the processor 11 provides the DC voltage VDC2 to the electrode 110 and further provides no voltage to the electrode 120. That is, in the period from the time point T4 to the time point T5, the processor 11 continuously applies the DC voltage VDC2 (V130=V1−V2=VDC2) to the reaction area 130 through the electrodes 110 and 120 (step S54). At this time, the processor 11 obtains a response-current value in response to the DC voltage 2VDC through the electrodes 110 and 120. After that, the processor 11 obtains the determination index according to the response-current values obtained in the step S50˜S54 (step S55).

According to the embodiment of FIG. 4, the processor 11 does not apply the voltage V130 to the reaction area 130 continuously. Particularly, in the period from the time point T2 to the time point T3, the processor 11 stops applying the voltage to the reaction 130. Moreover, since the DC voltages VDC and VDC2 are provided to the electrode 110 first and then provided to the electrode 120, the polarities of the applied voltages for the electrodes are inverse to each other. Thus, the induced response-current is switched from one direction to another direction. The response-current values, which are obtained in the steps S50˜S54, are processed by a specific operation of the processor 11 to obtain the determination index representing the filling situation of the biomolecular object in the reaction area 130. In the embodiment, the specific operation can be multiplication, division, ratio power functions, or logarithm.

After the time point T5, the biochemistry detection system 1 enters the detection mode 41 and then performs a specific detection operation (such as blood glucose detection operation) to the biomolecular object to detect the features of the biomolecular object for obtaining a detection value (step S56) and the detection value is corrected based on the obtained determination index, thereby enhancing the detection accuracy (step S57). In the embodiment, when the biochemistry detection system 1 enter the detection mode 41, the voltage which is provided to the reaction area 130 through the electrodes 110 and 120 is larger than the DC voltage VDC2. In an embodiment, the step S57 can be replaced to warn users or abnormally terminate the detection procedure according to the obtained determination index.

In the embodiment of FIG. 4, the DC voltage CDV and the DC voltage VDC2 which are provided to the electrodes 110 and 120 by the processor 11 are in the range of 0.001˜0.1V, and preferably in the range of 0.025˜0.01V. In an embodiment, both the DC voltage VDC and the DC voltage VDC2, which are provided to the electrodes 110 and 120, are 0.02V. In other words, in the period from the time point T0 to the time point T1 and the period from the time point T1 to the time point T2, the processor 11 applies the voltage V130 of −0.001˜−0.1V to the reaction area 130 through the electrodes 110 and 120; and in the period from the time point T3 to the time point T4 and the period from the time point T4 to the time point T5, the processor 11 applies the voltage V130 of 0.001˜0.1V to the reaction area 130 through the electrodes 110 and 120. In an embodiment, in the period from the time point T0 to the time point T1 and the period from the time point T1 to the time point T2, the processor 11 applies the voltage V130 of −0.025˜−0.01V to the reaction area 130 through the electrodes 110 and 120; and in the period from the time point T3 to the time point T4 and the period from the time point T4 to the time point T5, the processor 11 applies the voltage V130 of −0.025˜−0.01V to the reaction area 130 through the electrodes 110 and 120.

In the embodiment, the length of each of the periods from the time point T0 to the time point T1, from the time point T1 to the time point T2, from the time point T2 to the time point T3, from the time point T3 to the time point T4, and from the time point T4 to the time point T5, is in a range of 0.01˜1 s. In an embodiment, the length of each period between the every continuous time points listed above is 0.2 S. In another embodiment, the lengths of the periods each between every two continuous time points listed above are different. For example, the length of each of the periods from the time point T0 to the time point T1, from the time point T1 to the time point T2, from the time point T3 to the time point T4, and from the time point T4 to the time point T5 is longer than the length of the period from the time point T2 to the time point T3.

In the embodiment of FIG. 4, the filling determination mode 40 occurs before the biochemistry detection system 1 enters the detection mode 41. In other embodiments, the biochemistry detection system 1 operates in the detection mode 41 to obtain the detection value and then enters the filling determination mode 40 to obtain the determination index. After the determination index is obtained, the detection value is processed according to the determination index, such as, for warning users, abnormally terminating the detection procedure, or correcting the detection value.

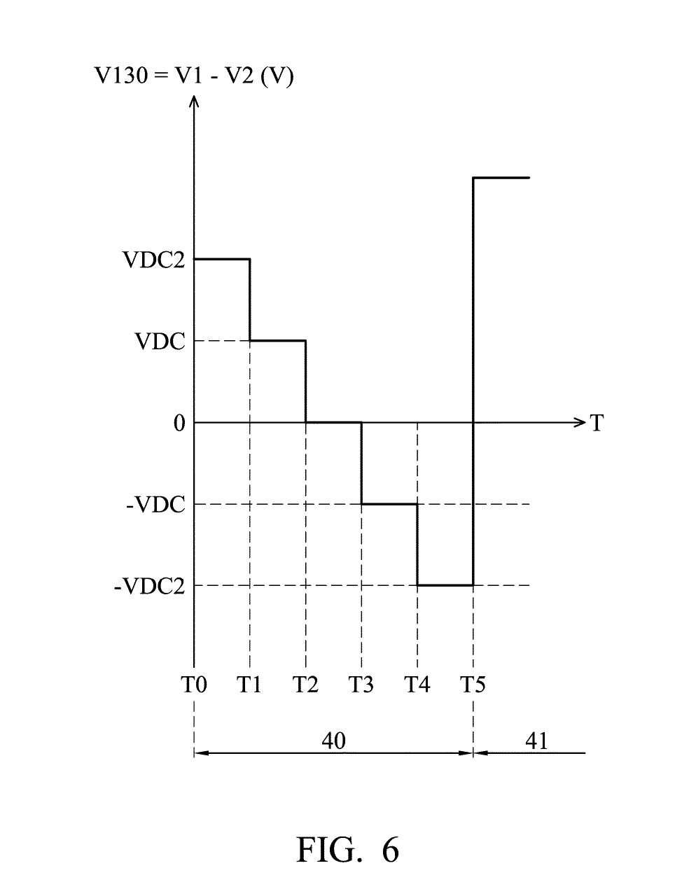

In the embodiment of FIG. 4, in the filling determination mode 40, the voltage which is provided to the reaction area 130 by the processor 11 increases gradually with time. In another embodiment, the voltage which is provided to the reaction area 130 by the processor 11 can decreases gradually with time, as shown in FIG. 6. The voltage-applying operation in FIG. 6 is similar to the voltage-applying operation in the above embodiment. Thus, the related description is omitted here.

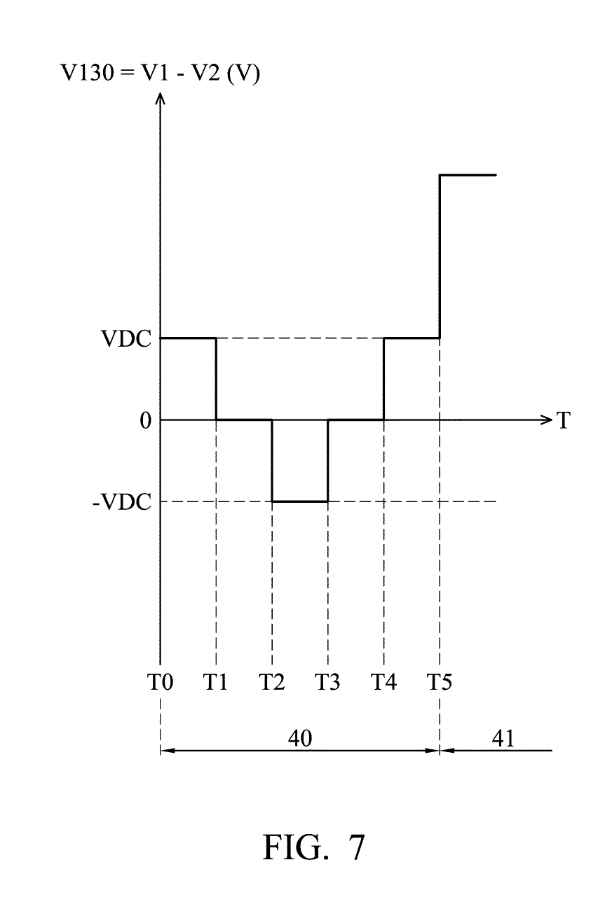

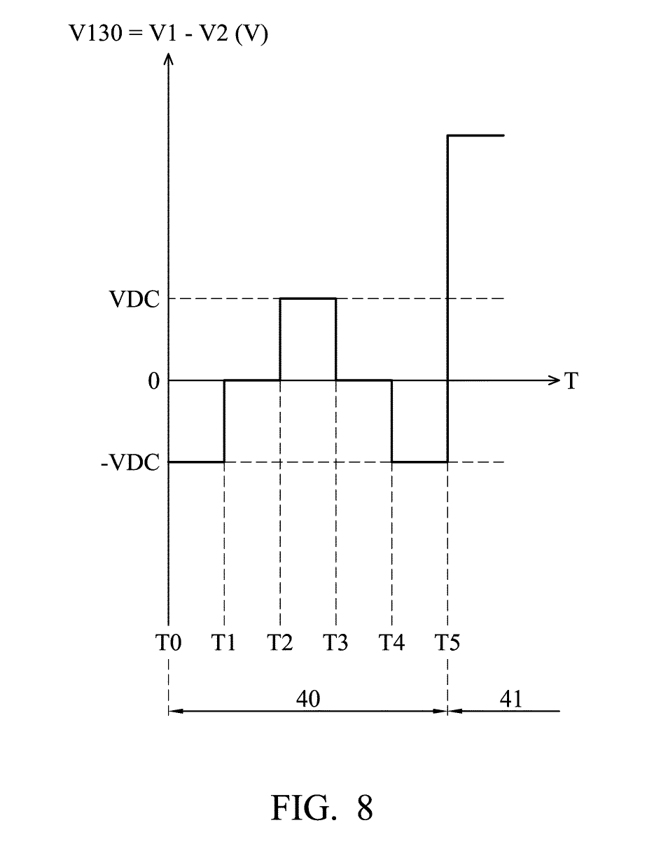

In further another embodiment, in the filling determination mode 40, the voltage which is provided to the reaction area 130 by the processor 11 increases gradually and then decreases gradually (shown in FIG. 7) or decreases gradually and then increases gradually (shown in FIG. 8). No matter whether the voltage which is provided to the reaction area 130 by the processor 11 increases gradually, decreases gradually, increases gradually and then decreases gradually, or decreases gradually and then increases gradually in the filling determination mode 40, the processor 11 has to stop applying any voltage to the reaction area 130 in at least one period (such as the period from time point T2 to the time point T3).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A determination method for a biochemistry detection strip which comprises a first electrode, a second electrode, and a reaction area coupled to the first electrode and the second electrode, the determination method comprising:
disposing a to-be-detected object in the reaction area;
applying a first voltage to the reaction area through the first electrode and the second electrode to obtain a first value;
stopping applying the first voltage to the reaction area for a first period;
applying a second voltage to the reaction area through the first electrode and the second electrode to obtain a second value;
stopping applying the second voltage to the reaction area for a second period; and
obtaining a determination index, which represents a filling situation of the to-be-detected object in the reaction area, according to the first value and the second value,
wherein a polarity of the first voltage and a polarity of the second voltage are inverse to each other.

2. The determination method as claimed in claim 1, wherein one of the first voltage and the second voltage is in a range of 0.001˜0.1V, and the other of the first voltage and the second voltage is in a range of −0.001˜−0.1V.

3. The determination method as claimed in claim 1, wherein in the step of obtaining the determination index, the first value and the second value are processed by multiplication, division, ratio power functions, or logarithm to obtain the determination value.

4. The determination method as claimed in claim 1, wherein a length of the first period and a length of the second period are in a range of 0.01˜1 second.

5. The determination method as claimed in claim 1,
wherein in the step of applying the first voltage, the first voltage is applied continuously for a third period,
wherein in the step of applying the second voltage, the second voltage is applied continuously for a fourth period, and
wherein a length of the at least one of the third period and the fourth period is different from lengths of the first period and the second period.

6. The determination method as claimed in claim 1,
wherein in the step of applying the first voltage, the first voltage is applied continuously for a third period,
wherein in the step of applying the second voltage, the second voltage is applied continuously for a fourth period, and
wherein lengths of the first period, the second period, the third period, and the fourth period are equal.

7. The determination method as claimed in claim 1, wherein before the step of applying the first voltage to the reaction area, the determination method further comprises:
applying a third voltage to the reaction area through the first electrode and the second electrode to obtain a third value,
wherein in the step of obtaining the determination index, the determination index is obtained according to the first value, the second value, and the third value.

8. The determination method as claimed in claim 7, wherein the third voltage, the first voltage, and the second voltage increase or decrease gradually.

9. The determination method as claimed in claim 1, wherein after the step of stopping applying the second voltage to the reaction area, the determination method further comprises:
applying a third voltage to the reaction area through the first electrode and the second electrode to obtain a third value,
wherein in the step of obtaining the determination index, the determination index is obtained according to the first value, the second value, and the third value.

10. The determination method as claimed in claim 9, wherein the first voltage, the second voltage, and the third voltage increase or decrease gradually.

11. A determination method for a biochemistry detection strip which comprises a first electrode, a second electrode, and a reaction area coupled to the first electrode and the second electrode, the determination method comprising:
(A) disposing a to-be-detected object in the reaction area;
(B) applying a first voltage to the reaction area through the first electrode and the second electrode to obtain a first value;
(C) stopping applying the first voltage to the reaction area for a first period;
(D) applying a second voltage to the reaction area through the first electrode and the second electrode to obtain a second value;
(E) stopping applying the second voltage to the reaction area for a second period; and
(F) repeatedly performing the steps (B)˜(E) at least once and obtaining a determination index, which represents a filling situation of the to-be-detected object in the reaction area, according to the obtained first values and the obtained second values.

12. The determination method as claimed in claim 11, wherein one of the first voltage and the second voltage is in a range of 0.001˜0.1V, and the other of the first voltage and the second voltage is in a range of −0.001˜−0.1V.

13. The determination method as claimed in claim 11, wherein in the step (F) of obtaining the determination index, the obtained first values and the obtained second values are processed by multiplication, division, ratio power functions, or logarithm to obtain the determination value.

14. The determination method as claimed in claim 11, wherein a length of the first period and a length of the second period are in a range of 0.01˜1 second.

15. The determination method as claimed in claim 11,
wherein in the step (B) of applying the first voltage, the first voltage is applied continuously for a third period,
wherein in the step (D) of applying the second voltage, the second voltage is applied continuously for a fourth period, and
wherein a length of the at least one of the third period and the fourth period is different from lengths of the first period and the second period.

16. The determination method as claimed in claim 11,
wherein in the step (B) of applying the first voltage, the first voltage is applied continuously for a third period,
wherein in the step (D) of applying the second voltage, the second voltage is applied continuously for a fourth period, and
wherein lengths of the first period, the second period, the third period, and the fourth period are equal.

17. The determination method as claimed in claim 11, wherein a polarity of the first voltage and a polarity of the second voltage are inverse to each other.

18. A determination method for a biochemistry detection strip which comprises a first electrode, a second electrode, and a reaction area coupled to the first electrode and the second electrode, the determination method comprising:
disposing a to-be-detected object in the reaction area;
applying a first voltage and a second voltage, which increase or decrease gradually, to the reaction area through the first electrode and the second electrode to respectively obtain a first value and a second value;
stopping applying the first voltage and the second voltage to the reaction area for a first period;
applying a third voltage and a fourth voltage, which increase or decrease gradually, to the reaction area through the first electrode and the second electrode to respectively obtain a third value and fourth value; and
obtaining a determination index, which represent a filling situation of the to-be-detected object in the reaction area, according to the first value, the second value, the third value, and the fourth value.

19. The determination method as claimed in claim 18, wherein a polarity of the first voltage and a polarity of the fourth voltage are inverse to each other, and a polarity of the second voltage and a polarity of the third voltage are inverse to each other.

20. The determination method as claimed in claim 18, wherein a polarity of the first voltage and a polarity of the second voltage are the same, and a polarity of the third voltage and a polarity of the fourth voltage are the same.
